(19) United States
(12) Patent Application Publication
(10) Pub. No.: US 2009/0155510 A1
(43) Pub. Date: Jun. 18, 2009

(54) Pad Structure

(76) Inventor: Hui-Mei CHEN, Shulin City (TW)

Correspondence Address: HDLS Patent & Trademark Services, P.O. BOX 220746, CHANTILLY, VA, 20153-0746, US

(21) Appl. No.: 11/959,302

(22) Filed: Dec. 18, 2007

(51) Int. Cl. B32B 1/08

(52) U.S. Cl. 428/36.1

(57) ABSTRACT

A pad structure is made a combination selectively combined from a group consisting of a thermoplastic polyurethane (TPU) film, a silicone gel material, and a cloth layer. The TPU film is configured for containing the silicone gel material. The cloth layer is arranged out of the TPU film, and at least one scotch is designed on an upper surface thereof to form the pad structure. The pad structure of the present invention, employ the silicone gel material to have an excellent pliancy. The TPU film can contain the silicone gel material to prevent the silicone gel material from leaking. The cloth layer can enhance the skidproof capability of the pad structure. The scotch is designed to make the pad structure prone to be bent and have the excellent breathe capability, such that the pad structure can increase the value of the objects and enhance the comfort of the users when the pad structure cooperates with the other objects.

### FIELD OF THE INVENTION

The present invention relates to pad structures, and more specifically, to a pad structure made of a combination combined selectively from a group consisting of (thermoplastic polyurethane) TPU films, silicone gel material, and cloth layers, and having at least one scotch thereon, such that the pad structure has functions with an excellent cushioning effect, an excellent product applicability, excellent tactility and pliancy, a good breathe capability and heat-dissipating capability, etc.

### DESCRIPTION OF THE RELATED ART

Conventional pad structures have an elasticity to cushion impacts produced by forces. Thus the pad structures are cooperated with various objects. For example, the pad structures may be manufactured into insoles, and be arranged in shoes. The pad structures may be also arranged in heelpieces, to decrease damages produced by rubbing between heels and the heelpieces. The above conventional pad structures are finished products; however, the conventional pad structures have some disadvantages in using as described following:

1. Most of the conventional pad structures are made of non silicone gel material; therefore, they are prone to be distorted or blemished in using for a long time.

2. If the conventional pad structures are mode of silicone gel material, they usually employ a film to contain the silicone gel material. Since the film is slippery, it is difficult to be fixed.

3. When the conventional pad structures cooperate with other objects, the conventional pad structures are usually bent for fitting the other objects. Since the conventional pad structures have the elasticity, large forces are needed to overcome restoring forces produced by the conventional pad structures.

Therefore, the above conventional pad structures have many disadvantages to be solved.

What is needed is a pad structure which can solve the above problems.

### BRIEF SUMMARY

An object of the present invention is providing a pad structure, which employs the silicone gel material to have an excellent pliancy, employs a TPU film configured for containing the silicone gel material to prevent the silicone gel material from leaking, employs a cloth layer configured for enhancing the skidproof capability of the pad structure, and employs at least one scotch to make the pad structure prone to be bent and have the excellent breathe capability, such that the pad structure can increase the value of the objects and enhance the comfort of the users when the pad structure cooperates with the other objects.

Another object of the present invention is providing a pad structure, which can cooperate with many objects, such as shoes, bra straps, kitbags, mattresses, bras etc., to enhance the comfort of the objects, and decrease the press and burden of the users in using for a long time.

Another object of the present invention is providing a pad structure, which has many advantages, such as, the high comfort, the excellent breathe capability, the excellent cushioning capability, the elastic size, the wide using range, etc.

The pad structure in accordance with a preferred embodiment of the present invention is made a combination selectively combined from a group consisting of a TPU film, a silicone gel material, and a cloth layer. The TPU film is configured for containing the silicone gel material. The cloth layer is arranged out of the TPU film, and at least one scotch is designed on an upper surface thereof to form the pad structure.

Other objects, advantages and novel features of the invention will become more apparent from the following detailed description when taken in conjunction with the accompanying drawings, in which:

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A is a schematic, exploded view of a pad structure of a first preferred embodiment of the present invention;

FIG. 1B is a schematic, cross-sectional view of the pad structure of FIG. 1A;

FIG. 2A is a schematic, exploded view of a pad structure of a second preferred embodiment of the present invention;

FIG. 2B is a schematic, crossed-sectional view of the pad structure of FIG. 2A;

FIG. 3A is a schematic, exploded view of a pad structure of a third preferred embodiment of the present invention;

FIG. 3B is a schematic, crossed-sectional view of the pad structure of FIG. 3A;

FIG. 4A is a schematic, exploded view of a pad structure of a fourth preferred embodiment of the present invention;

FIG. 4B is a schematic, crossed-sectional view of the pad structure of FIG. 4A;

FIG. 5 is a schematic, view of the pad structure cooperating with a shoe.

FIG. 6 is a schematic, view of the pad structure cooperating with a bra aiguillette.

FIG. 7 is a schematic, view of the pad structure cooperating with a kitbag gallus.

FIG. 8 is a schematic, view of the pad structure cooperating with a mattress.

FIG. 9 is a schematic, view of the pad structure cooperating with a bra.

### DETAILED DESCRIPTION

Reference will now be made to the drawings to describe a preferred embodiment of the present bra pad, in detail.

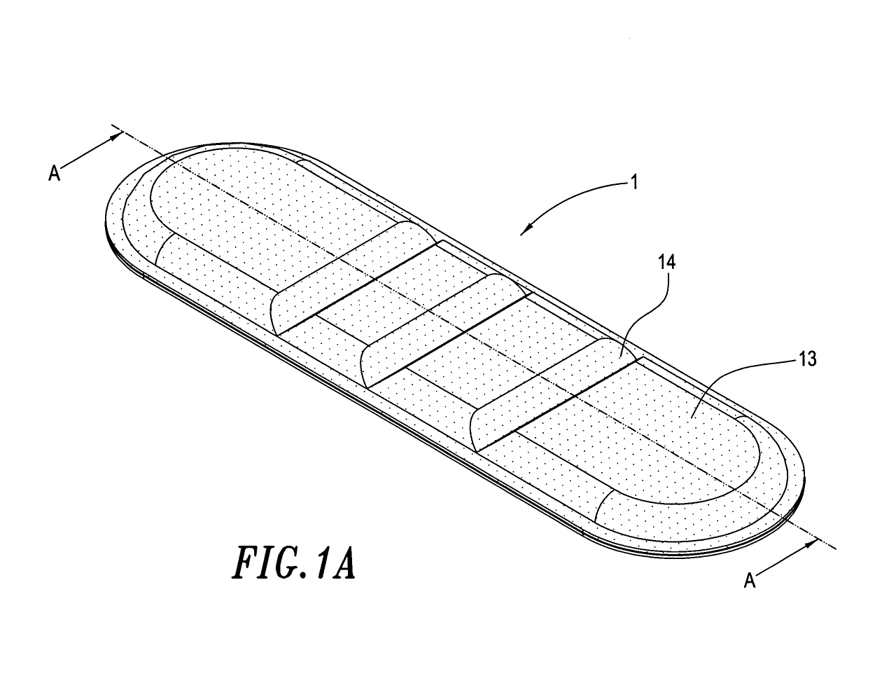

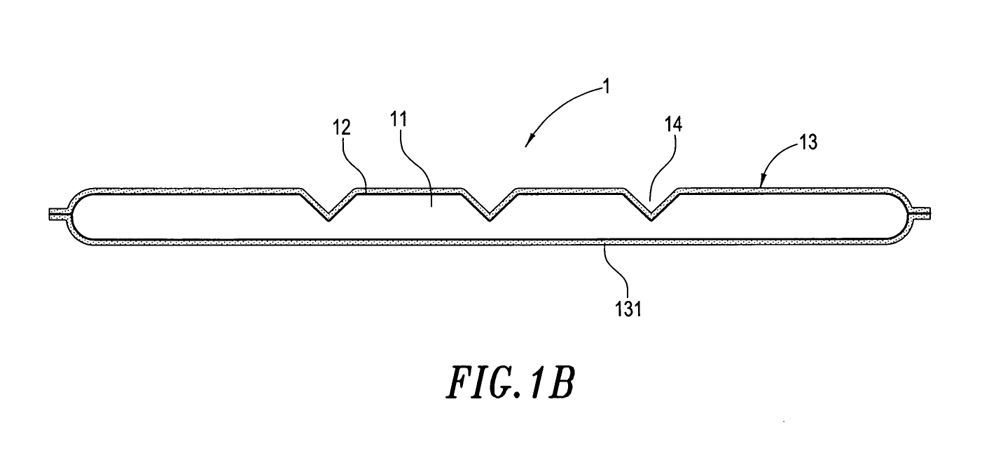

Referring to FIGS. 1A and 1B, a pad structure 1 in accordance with a first preferred embodiment of the present invention is shown. The pad structure 1 includes a silicone gel material 11, a polyurethane (TPU) film 12, and a cloth layer 13.

The silicone gel material 11 may be liquid-state silicone gel, or liquid-state silicone rubber.

The TPU film 12 is configured for containing the silicone gel material 11.

The cloth layer 13 is configured for containing an upper surface and a lower surface of the TPU film 12.

The silicone gel material 11, the TPU film 12 and the cloth layer 13 are combined, and then at least one scotch 14 are formed on the upper surface thereof to form the pad structure 1. The cloth layer 131 attaching on the lower surface may be a velveteen to couple with felts of the other objects for being located.

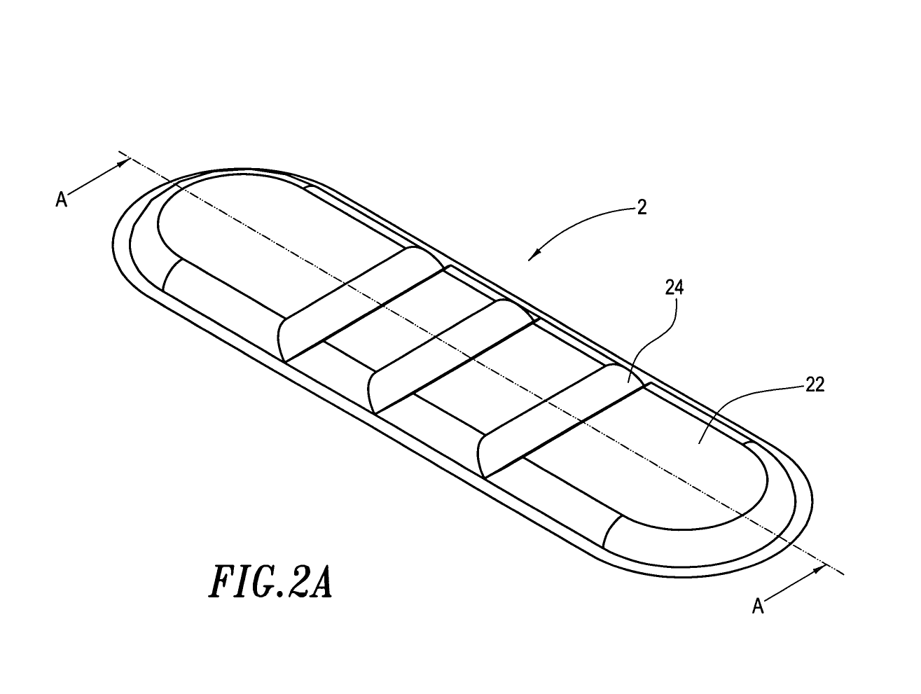

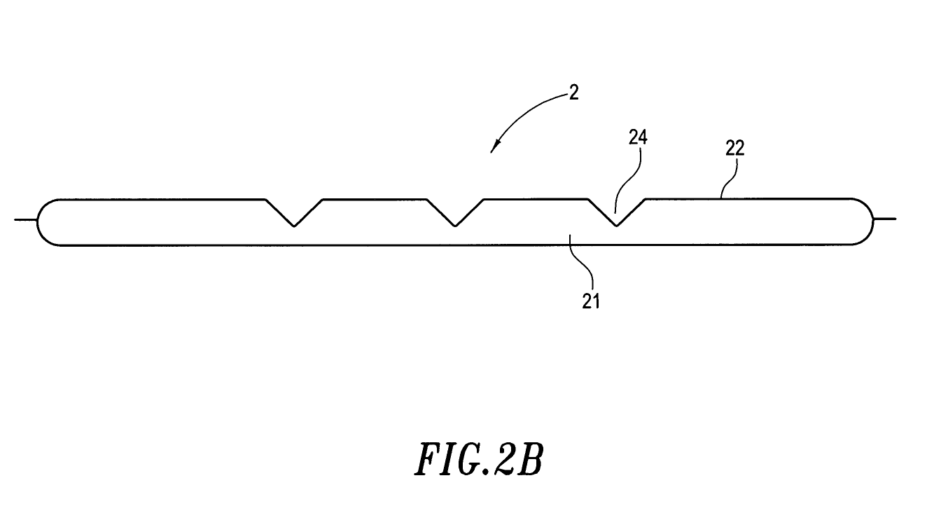

Referring to FIGS. 2A and 2B, a pad structure 2 in accordance with a second preferred embodiment of the present invention is shown. The pad structure 2 includes a silicone gel material 21, and a TPU film 22.

The silicone gel material 21 may be liquid-state silicone gel, or liquid-state silicone rubber.

The TPU film 22 is configured for containing the silicone gel material 21.

The silicone gel material 21 and the TPU film 22 are combined, and then at least one scotch 24 are formed on an upper surface thereof to form the pad structure 2.

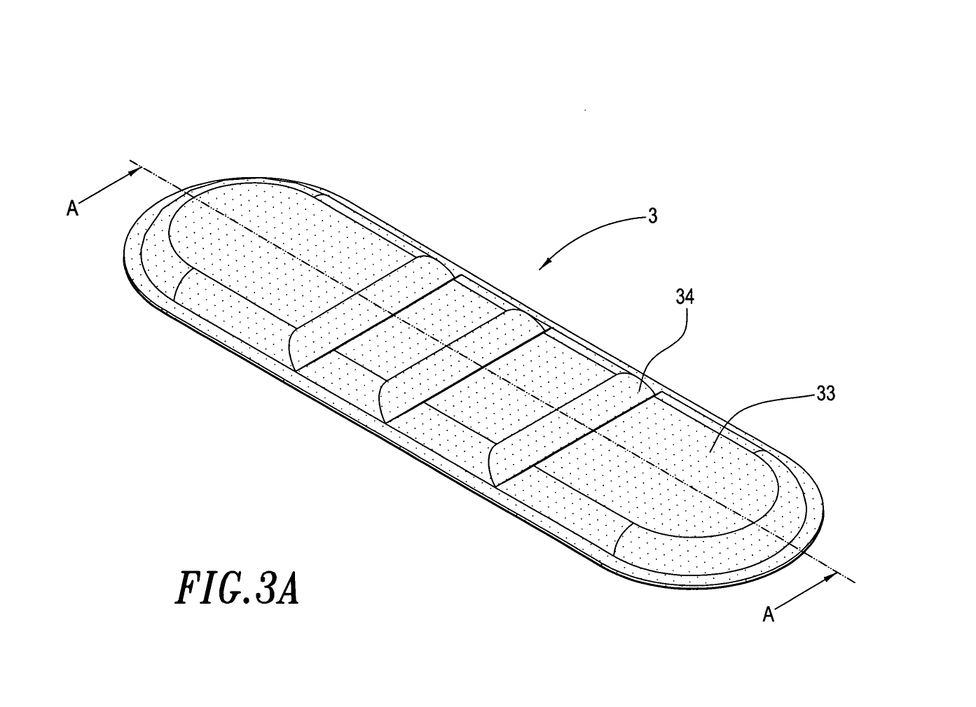

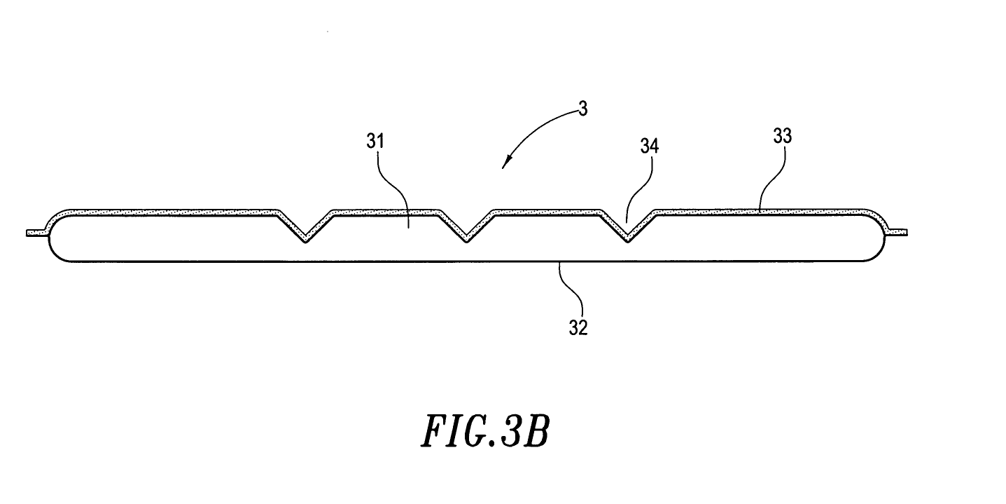

Referring to FIGS. 3A and 3B, a pad structure 3 in accordance with a third preferred embodiment of the present invention is shown. The pad structure 3 includes a silicone gel material 31, a TPU film 32, and a cloth layer 33.

The silicone gel material 31 may be liquid-state silicone gel, or liquid-state silicone rubber.

The TPU film 32 is configured for containing the silicone gel material 31.

The cloth layer 33 is arranged on an upper surface of the TPU film 32.

The silicone gel material 31, the TPU film 32 and the cloth layer 33 are combined, and then at least one scotch 34 are formed on the upper surface thereof to form the pad structure 3.

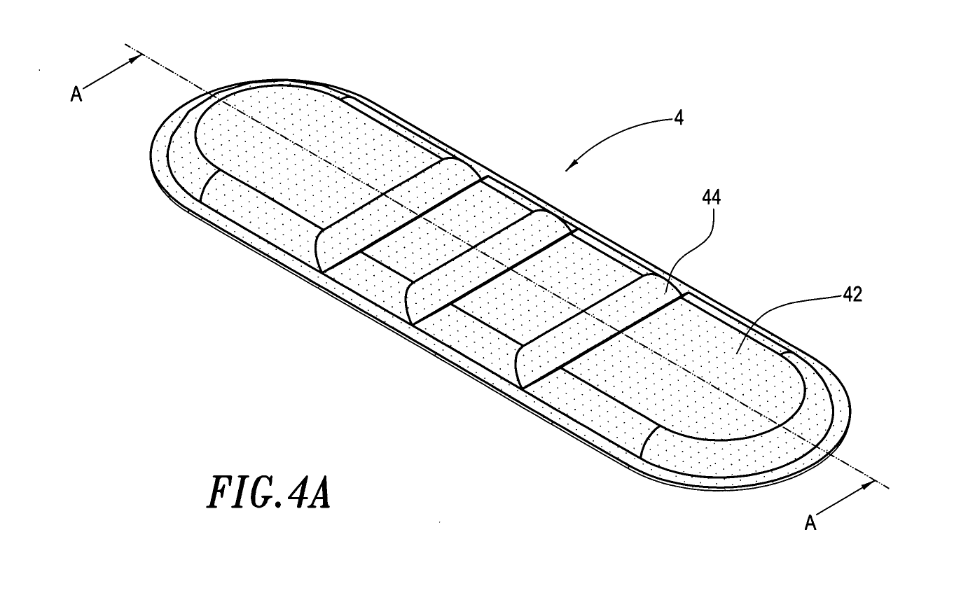

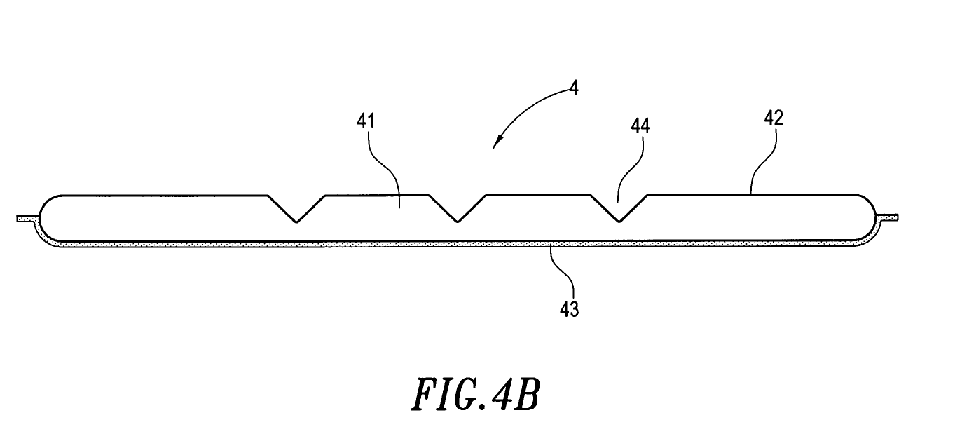

Referring to FIGS. 4A and 4B, a pad structure 4 in accordance with a fourth preferred embodiment of the present invention is shown. The pad structure 4 includes a silicone gel material 41, a TPU film 42, and a cloth layer 43.

The silicone gel material 41 may be liquid-state silicone gel, or liquid-state silicone rubber.

The TPU film 42 is configured for containing the silicone gel material 41.

The cloth layer 43 is arranged on a lower surface of the TPU film 42.

The silicone gel material 41, the TPU film 42 and the cloth layer 43 are combined, and then at least one scotch 44 are formed on the upper surface thereof to form the pad structure 4. The cloth layer 43 attaching on the lower surface thereof may be a velveteen to couple with felts of the other objects for being located.

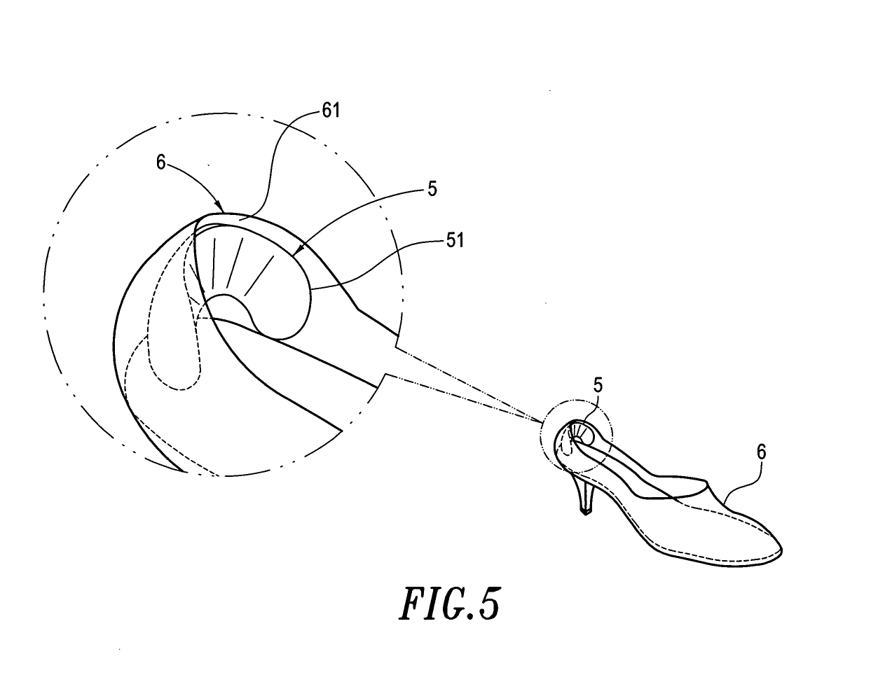

Referring to FIG. 5, the pad structure of the present invention cooperating with a shoe is shown. In FIG. 5, the pad structure 5 cooperates with a high-heel shoe. The pad structure 5 is arranged on the heel 61. Since the pad structure 5 has an excellent pliancy and at least one scotch 51, the pad structure 5 is prone to be bent, and has an excellent breathe capability to protect heels of users effectively.

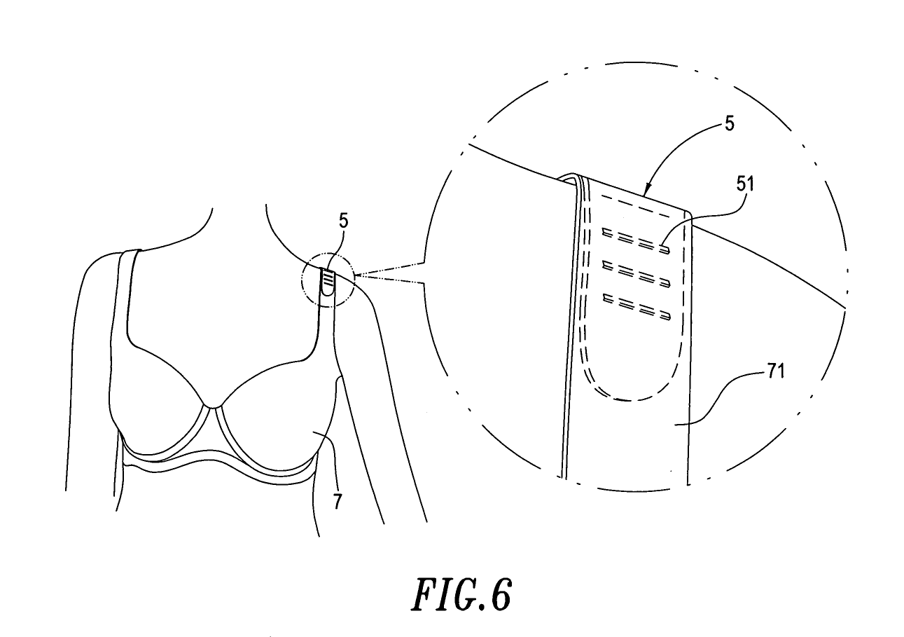

Referring to FIG. 6, the pad structure of the present invention cooperating with a bra strap is shown. In FIG. 6, the pad structure 5 cooperates with a bra 7. The pad structure 5 is arranged in a strap 71 of the bra 7. Since the pad structure 5 has an excellent pliancy and at least one scotch 51, the pad structure 5 is prone to be bent, such that the pad structure 5 can decrease effectively the burden of the users for carrying the bra 7 in a long time.

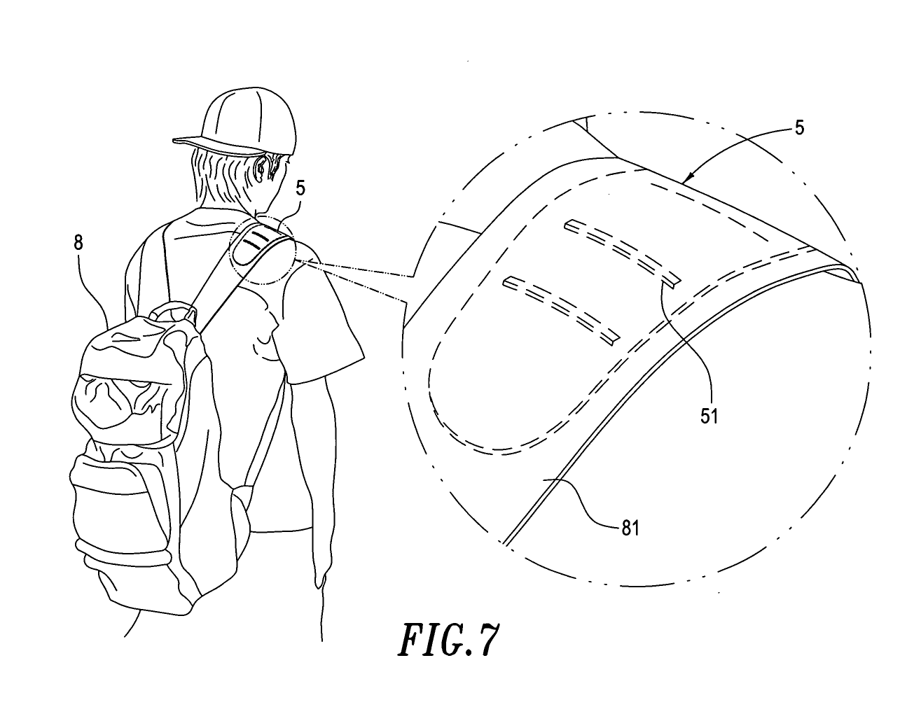

Referring to FIG. 7, the pad structure of the present invention cooperating with a kitbag gallus is shown. In FIG. 6, the pad structure 5 cooperates with a kitbag 8. The pad structure 5 is arranged in a gallus 81 of the kitbag 8. Since the pad structure 5 has an excellent pliancy and at least one scotch 51, the pad structure 5 is prone to be bent, such that the pad structure 5 can decrease effectively the burden of the users for carrying the kitbag 8 in a long time.

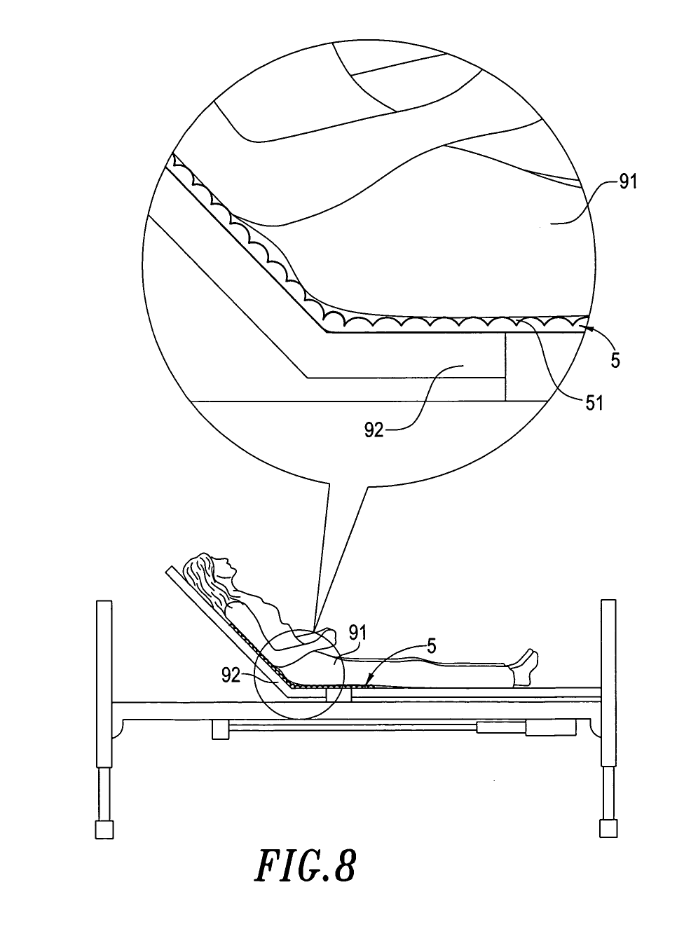

Referring to FIG. 8, the pad structure of the present invention cooperating with a mattress is shown. In FIG. 8, the pad structure 5 cooperates with a mattress 92. The pad structure 5 is arranged in the mattress 92. Since the pad structure 5 has an excellent pliancy and at least one scotch 51, the pad structure 5 is prone to be bent. Further gaps are defined between the scotch 51 and patients 91 to produce an excellent breathe capability, such that the pad structure 5 can avoid the discomfort of the patients 91 produced by laying on the mattress 92 in a long time.

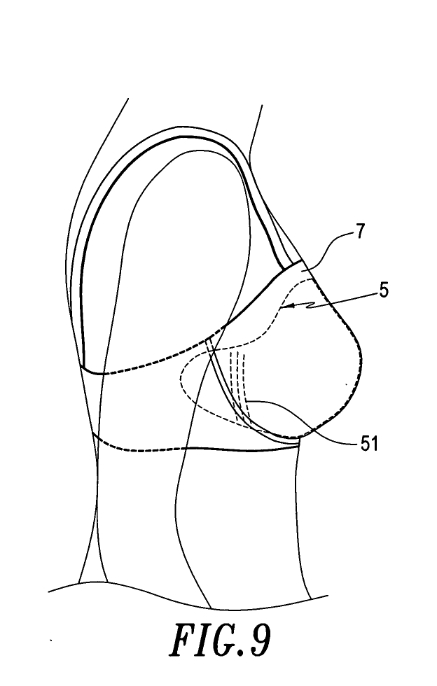

Referring to FIG. 9, the pad structure of the present invention cooperating with a bra is shown. In FIG. 9, the pad structure 5 cooperates with a bra 7. The pad structure 5 is arranged between user's breast and the bra 7. Since the pad structure 5 has an excellent pliancy and at least one scotch 51, the pad structure 5 is prone to be bent to closely contact with the user, and a gap between user's skin and the scotch 51 provides good breathe effect for wearing the bar 7.

From FIGS. 5-9, the pad structure of the present invention can cooperate with many objects, to enhance the comfort of the objects, and decrease the press and burden of the users for using in a long time.

Comparing with the conventional arts, the bra pads of the present invention have the following advantages:

1. The pad structure of the present invention, employ the silicone gel material to have an excellent pliancy. The TPU film can contain the silicone gel material to prevent the silicone gel material from leaking. The cloth layer can enhance the skidproof capability of the pad structure. The scotch is designed to make the pad structure prone to be bent and have the excellent breathe capability, such that the pad structure can increase the valve of the objects and enhance the comfort of the users when the pad structure cooperates with the other objects.

2. The pad structure of the present invention can cooperate with many objects, such as shoes, bras straps, kitbags, mattresses, bras, etc., to enhance the comfort of the objects, and decrease the press and burden of the users for using in a long time.

3. The pad structure of the present invention has many advantages, such as, the high comfort, the excellent breathe capability, the excellent cushioning capability, the elastic size, the wide using range, and etc.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A pad structure comprising:
a silicone gel material;
a thermoplastic polyurethane (TPU) film configured for containing the silicone gel material; and
a cloth layer configured for containing an upper surface and a lower surface of the TPU film,
wherein the silicone gel material, the TPU film and the cloth layer are combined together with at least one scotch formed on the upper surface.

2. The pad structure as claimed in claim 1, wherein the silicone gel material is selected from a group consisting of liquid-state silicone gel and liquid-state silicone rubber.

3. The pad structure as claimed in claim 1, wherein the cloth layer attaching on the lower surface thereof is a velveteen.

4. A pad structure, comprising:
a silicone gel material; and
a thermoplastic polyurethane (TPU) film configured for containing the silicone gel material,
wherein the silicone gel material and the TPU film are combined together with at least one scotch formed on an upper surface of the TPU film.

5. The pad structure as claimed in claim 4, wherein the silicone gel material is selected from a group consisting of liquid-state silicone gel and liquid-state silicone rubber.

6. A pad structure, comprising:
a silicone gel material;
a thermoplastic polyurethane (TPU) film configured for containing the silicone gel material; and
a cloth layer attaching on an upper surface of the TPU film,
wherein the silicone gel material, the TPU film and the cloth layer are combined together with at least one scotch formed on the upper surface.

7. The pad structure as claimed in claim 6, wherein the silicone gel material is selected from a group consisting of liquid-state silicone gel and liquid-state silicone rubber.

8. A pad structure, comprising:
a silicone gel material;
a TPU film configured for containing the silicone gel material; and
a cloth layer attaching on a lower surface of the TPU film,
wherein the silicone gel material, the TPU film and the cloth layer are combined together with at least one scotch are formed on an upper surface.

9. The pad structure as claimed in claim 8, wherein the silicone gel material is selected from a group consisting of liquid-state silicone gel and liquid-state silicone rubber.

10. The pad structure as claimed in claim 8, wherein the cloth layer attaching on the lower surface thereof is a velveteen.
